(19) United States
(12) Patent Application Publication
(10) Pub. No.: US 2014/0252945 A1
(43) Pub. Date: Sep. 11, 2014

(54) MERCURY VAPOR SHORT ARC LAMP FOR DC OPERATION WITH CIRCULAR PROCESS

(71) Applicant: Matthias Morkel, Berlin (DE)

(72) Inventor: Matthias Morkel, Berlin (DE)

(73) Assignee: OSRAM GMBH, Muenchen (DE)

(21) Appl. No.: 14/352,060

(22) PCT Filed: Sep. 14, 2012
(86) PCT No.: PCT/EP2012/068164

§ 371 Date: Apr. 16, 2014

(30) Foreign Application Priority Data
Oct. 20, 2011 (DE) 10201184911.4

(51) Int. Cl. H01J 61/20

(52) U.S. Cl. CPC H01J 61/20
USPC 313/640; 313/639; 313/642

(57) ABSTRACT

A mercury vapor short arc lamp for DC operation may include a cathode and an anode arranged in an interior of a discharge vessel, wherein the atmosphere in the interior contains at least one halogen or one halogen compound, and the mercury density in the interior is between 1 and 60 mg/cm³.

### RELATED APPLICATIONS

The present application is a national stage entry according to 35 U.S.C. §371 of PCT application No.: PCT/EP2012/068164 filed on Sep. 14, 2012, which claims priority from German application No.: 10 2011 084 911.4 filed on Oct. 20, 2011, and is incorporated herein by reference in its entirety.

### TECHNICAL FIELD

Various embodiments relate to a mercury vapor short arc lamp.

### BACKGROUND

Mercury vapor short arc lamps (for example, OSRAM HBO®) are primarily used in the semiconductor industry, specifically as so-called i-line lamps, which preferably emit useful radiation in the wavelength range around 365 nm (microchip lithography), or as so-called LCD lamps, which preferably emit useful radiation in the wavelength range from 350 to 450 nm (LCD lithography), respectively.

A DC-operated mercury vapor short arc lamp for applications in i-line (365 nm) micro-lithography is known from DE 102 09 426 A1. This lamp has an ellipsoidal discharge vessel (lamp bulb), which encloses an anode and a cathode made of tungsten and contains a filler made of noble gas and mercury.

One problem during the operation of mercury vapor short arc lamps is the vaporization (sputtering effect) of electrode material (for example, tungsten) and the blackening of the inner wall of the lamp bulb thus caused, which becomes stronger with increasing operating duration, which results in reduced radiated power and increased bulb temperature.

It is known that halogens reduce the blackening of the lamp bulb during the operating time by way of the so-called halogen circular process. The sequence of the halogen circular process can be described as follows. As a result of the high operating temperature in the bulb, the tungsten atoms vaporize from the cathode and the anode. Most of these atoms are captured by the halogens while forming halogen compounds, instead of accumulating on the bulb wall. The blackening of the lamp bulb is thus significantly reduced.

The application of a halogen circular process in discharge lamps using mercury chemistry and mercury concentrations of greater than 150 to 200 mg/cm³ is known, however, minimum temperatures (cold spot temperatures) of greater than 800° C. must be ensured in the interior of the lamp, since otherwise the halogen circular process no longer functions.

In discharge lamps using mercury chemistry and mercury concentrations of up to 60 mg/cm³ and temperatures in the interior of the lamp (cold spot temperatures) in the range from 500 to 750° C., an effective circular process method, which can minimize or even suppress the bulb blackening, is not known.

### SUMMARY

Various embodiments provide, for mercury vapor short arc lamps using mercury concentrations of up to approximately 60 mg/cm³ in DC operation, a circular process, which also effectively functions at lower temperatures (cold spot temperatures) in the interior of the lamp, so that blackening of the inner wall of the lamp bulb can be effectively prevented.

Various embodiments relate to a mercury vapor short arc lamp, having a cathode and anode arranged in an interior of a discharge vessel, which is characterized in that the atmosphere in the interior contains at least one halogen or one halogen compound, and the mercury density in the interior, in the case of the so-called i-line (narrowband ultraviolet emission at 365 nm) mercury vapor short arc lamps (for example, OSRAM HBO lamps for i-line lithography), is between 1 and 3 mg/cm³ or, in the case of so-called broadband ultraviolet mercury short arc lamps (for example, OSRAM HBO lamps for LCD lithography), is between 20 and 60 mg/cm³.

This solution has the advantage that a halogen circular process can be implemented in particular in HBO i-line and LCD lamps in spite of lower operating temperatures (temperature in the interior of the discharge vessel).

According to various embodiments, concentration ranges of a halogen or a halogen compound are specified, which also allow an effective halogen circular process in the case of mercury vapor short arc lamps having mercury concentrations of up to approximately 60 mg/cm³ and in the case of which undesired overreactions of the circular process do not occur.

The addition of halogens or halogen compounds is distinguished in particular in that they can be metered very well. The oxygen which is possibly inherently contained in these halogenides as a contaminant accelerates the desired reaction in the circular process.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a longitudinal section through an HBO discharge lamp according to one exemplary embodiment and

FIG. 2 shows the service life behavior of an HBO 3500 W lamp having tungsten oxyhalogenide additive in the discharge vessel in comparison to two corresponding lamps without tungsten oxyhalogenide additive.

### DETAILED DESCRIPTION

The following detailed description refers to the accompanying drawing that show, by way of illustration, specific details and embodiments in which the disclosure may be practiced.

The disclosure will be explained hereafter on the basis of a DC-operated mercury vapor short arc lamp (OSRAM HBO 3500 W/PI). In this mercury vapor short arc lamp, the atmosphere includes mercury vapor, a halogen or halogen compound, and a noble gas as a starter gas.

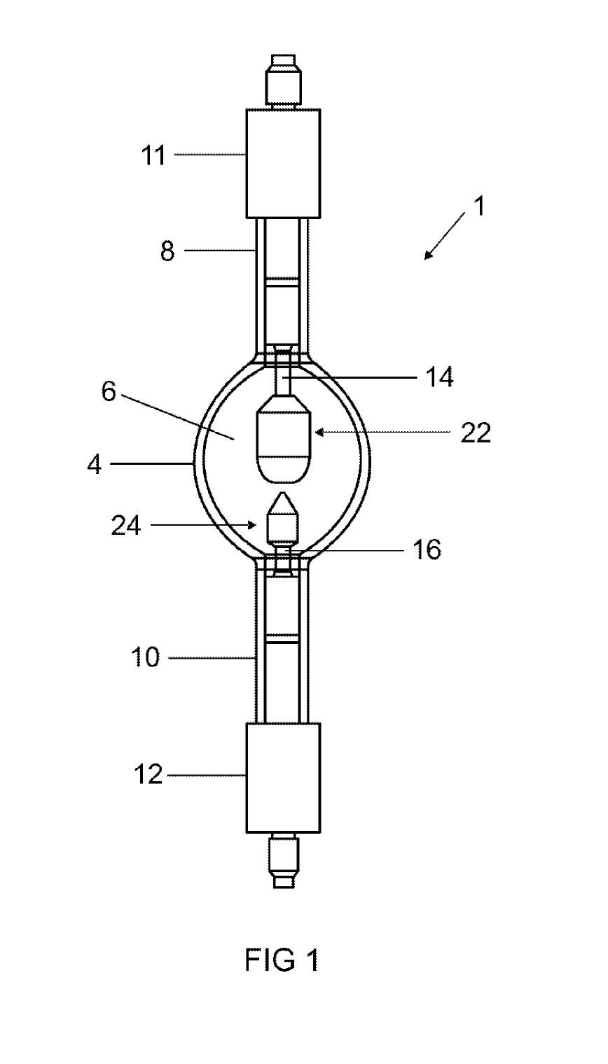

FIG. 1 shows a schematic illustration of a high-pressure discharge lamp 1, which has a two-sided base, in short arc technology, it has a discharge vessel 4 made of quartz glass having a discharge chamber 6 and two bulb shafts 8, 10, which are arranged diametrically opposed on the discharge vessel 4 and the free end sections of which are each provided with a base sleeve 11, 12. Two electrode rods 14, 16, between which a gas discharge (electric arc) occurs during the lamp operation, and which extend in the bulb shafts 8, 10, protrude into the discharge chamber 6. A filling made of mercury vapor and tungsten oxyhalogenide and optionally an inert gas is enclosed in the discharge chamber 6 of the discharge vessel 4.

The electrode rods 14, 16 are each electrically conductively connected to the base sleeves 11, 12 via a gas-tight power supply system (not shown in greater detail) in each of the two bulb shafts 8, 10. On the discharge side, the electrode rods 14, 16 are connected to an anode 22 or a cathode 24, respectively. According to the figure, the cathode 24, which is arranged at the bottom, for generating higher temperatures, is implemented having a conical tip to ensure a defined arch spring and a sufficient electrode flow as a result of thermal emission and field emission. The thermally highly loaded anode 22, which is on top in the figure, and is made of tungsten, for example, is embodied as substantially barrel-shaped, wherein the thermal emission power (heat dissipation) is improved by sufficient dimensioning of the electrode size.

The mercury density in the interior 6 of the discharge vessel 4 is preferably between 1-3 mg/cm³ (i-line lamps) or 20-60 mg/cm³ (LCD lamps), respectively, which corresponds to a low mercury density. In operation, the mercury vapor pressure in the discharge lamp according to the disclosure is less than 100 bar.

The halogen and/or halogen compound introduced into the atmosphere in the interior 6 of the discharge vessel 4 is preferably a metal oxyhalogenide, wherein metal oxyhalogenides of rare earth elements and of metals having emission lines in the visible range and UV range are excluded.

In one special embodiment of the present disclosure, the metal oxyhalogenide is a tungsten oxyhalogenide, which is selected from the group of tungsten oxychloride, tungsten oxybromide, tungsten oxyiodide, and mixtures thereof. Tungsten oxychloride and tungsten oxybromide are very particularly preferred. Metal oxyhalogenides are solids and are simple to meter.

For the case in which the halogen compound does not contain oxygen, oxygen can be metered into the interior in stoichiometric quantities, which accelerates the circular process.

The concentration of chlorine from the halogen compounds in the atmosphere in the interior is to be in a range from 0.1-25 μg/cm³ in a preferred embodiment of the disclosure. In the case of bromine, the concentration is preferably 0.3-100 μg/cm³.

It has been shown according to the disclosure that the following concentration ranges are to be used for the halogenides in i-line lamps and LCD lamps in relation to the mercury density.

i-Line Lamps (1 kW-10 kW)
Mercury Density: 1-3 mg/cm³
Cold Spot Temperature: 500° C.-700° C.
Chlorine Concentration: 0.1-10 μg/cm³
and/or Bromine Concentration: 0.3-50 μg/cm³

LCD Lamps
Mercury Density: 20-60 mg/cm³
Cold Spot Temperature: 600° C.-750° C.
Chlorine Concentration: 0.2-25 μg/cm³
and/or Bromine Concentration: 1-100 μg/cm³

The circular process is also maintained at lower temperatures by the addition of at least one halogen or one halogen compound into the mercury atmosphere in the interior 6. Thus, the temperature in the interior of the discharge vessel 4 is preferably at most 750° C., preferably between 700° C. and 600° C. (LCD lamps) or 700° C. and 500° C. (i-line lamps), respectively.

In a further embodiment of the discharge lamp according to the disclosure, furthermore an inert gas or a mixture of inert gases is contained in the discharge vessel 4. In a special embodiment, the inert gas is argon.

The vapor pressure of the inert gas or inert gases in the discharge vessel 4 is preferably between 1 mbar and approximately 5 bar. The tungsten vaporization can be slowed by the high pressure.

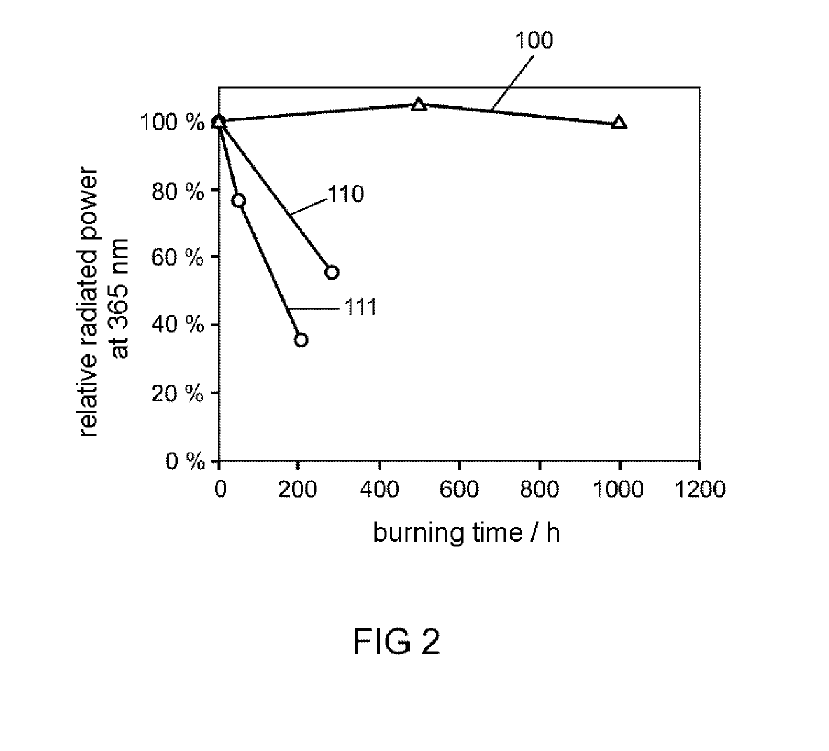

FIG. 2 shows the time curve 100 of the radiated power of the i-line (365 nm) of an HBO 3500 W/PI lamp (approximately 3500 W/160 A current strength), which was filled according to the disclosure with approximately 1.2 mg tungsten oxychloride (WO₂Cl₂), which corresponds to an effective quantity of 0.3 mg chlorine. The significantly smaller decrease of the i-line radiation emission over time can be recognized in comparison to reference lamps 110, 111, which do not contain tungsten oxyhalogenide. No getter was used here. The mercury filling was 540 mg, the argon filling pressure was 850 mbar. No anode paste application was performed.

As an example of an LCD lamp, a DC-operated HBO 8000 W/C lamp was filled with 6 mg WO₂Cl₂—which corresponds to an effective quantity of 1.5 mg chlorine—and also 600 mbar argon and 40 g mercury. This lamp was kept in operation for 960 hours. It did not display any perceptible blackening, in particular also not in the lower bulb region.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A mercury vapor short arc lamp for DC operation, comprising a cathode and an anode arranged in an interior of a discharge vessel, wherein the atmosphere in the interior contains at least one halogen or one halogen compound, and the mercury density in the interior is between 1 and 60 mg/cm³.

2. The mercury vapor short arc lamp as claimed in claim 1, wherein the halogen compound is a metal halogenide, wherein metal halogenides of rare earth elements and of metals having emission lines in the visible range and UV range are not present in the discharge vessel.

3. The mercury vapor short arc lamp as claimed in claim 2, wherein the metal halogenide is from the group tungsten oxychloride, tungsten oxybromide, tungsten oxyiodide, or mixtures thereof.

4. The mercury vapor short arc lamp as claimed in claim 3, wherein the concentration of chlorine in the atmosphere is 0.1 to 25 μg/cm³.

5. The mercury vapor short arc lamp as claimed in claim 3, wherein the concentration of bromine in the atmosphere is 0.3 to 100 μg/cm³.

6. The mercury vapor short arc lamp as claimed in claim 1, wherein it is designed for a temperature in the interior of the discharge vessel during operation of at most 750° C.

7. The mercury vapor short arc lamp as claimed in claim 6, wherein it is designed for a temperature in the interior of the discharge vessel during operation in a range between 700° C. and 600° C. or 700° C. and 500° C., respectively.

8. The mercury vapor short arc lamp as claimed in claim 1, wherein an inert gas or a mixture of inert gases is contained in the discharge vessel.

9. The mercury vapor short arc lamp as claimed in claim 8, wherein the inert gas is argon.

10. The mercury vapor short arc lamp as claimed in claim 8, wherein the vapor pressure of the inert gas or inert gases is between 1 mbar and 5 bar.

11. The mercury vapor short arc lamp as claimed in claim 9, wherein the vapor pressure of the inert gas or inert gases is between 1 mbar and 5 bar.
